(19) United States
(12) Patent Application Publication
(10) Pub. No.: US 2007/0283601 A1
(43) Pub. Date: Dec. 13, 2007

(54) Method For Manufacturing A Customized Coin

(75) Inventor: Diane L. Peterson, Krugerville, TX (US)

Correspondence Address: THORPE NORTH & WESTERN, LLP., 8180 SOUTH 700 EAST, SUITE 350, SANDY, UT, 84070, US

(73) Assignee: ATITANIA LTD., Krugerville, TX (US)

(21) Appl. No.: 11/742,550

(22) Filed: Apr. 30, 2007

Related U.S. Application Data
(62) Division of application No. 10/815,459, filed on Mar. 31, 2004, now abandoned.
(60) Provisional application No. 60/469,679, filed on May 9, 2003.
(60) Provisional application No. 60/459,041, filed on Mar. 31, 2003.

(51) Int. Cl. B28B 1/14

(52) U.S. Cl. 40/27.5

(57) ABSTRACT

A method is provided for manufacturing a layered memory object. The method includes the operation of producing a first coin layer from a precious metal using mass production techniques. A second coin layer can be created using a material that is less expensive than the first coin layer. The second coin layer can be customized with a customizable image. The first and second coin layers can be adhered together. The customized image can be configured to be viewed by a coin viewer.

### PRIORITY CLAIM

This is a divisional application of U.S. Non-Provisional application Ser. No. 10/815,459 filed Mar. 31, 2004 which claims priority to U.S. Provisional Application No. 60/469,679 filed May 9, 2003 and U.S. Provisional Application 60/459,041 filed Mar. 31, 2003.

### FIELD OF THE INVENTION

The present invention relates generally to layered memory objects.

### BACKGROUND

Most people are sentimental to one degree or another. As a result of this human quality of sentimentality, individuals like to purchase or receive objects that they associate with events, places, things, or people in their life. For example, when individuals graduate from school training, such as high school or college, quite often they will purchase a class ring. Unfortunately, women do not like class rings because they are quite bulky and relatively expensive. In addition, they are typically not beautiful or a quality jewelry item. This does not mean that women or even men have not had a good school experience but this means they do not like the specific memory item associated with their schooling.

There are also other memory items that individuals like to collect. Examples of these are thimbles, spoons, cups, cards, hats, shirts and similar items that are based on a location a person has visited. Although these items identify a specific location, they do not have any further date markings, manufacturing location markings, or other items of interest associated with the goods. Most of the items that are collected by individuals are random odds and ends that are eventually stuffed away in a drawer. One reason they are eventually put in a box is because they are not that beautiful or interesting anyway. Another reason such items are stored away is because of the significant amount of space the memory items occupy.

Eventually these memory items collect dust and are discarded. It is unfortunate that these items, which are associated with good memories, are discarded because it would be valuable to have items that could be displayed for many years or that are beautiful and can be mounted on a wall. Even items that are expensive may collect dust or break and then be discarded.

### SUMMARY OF THE INVENTION

A method is provided for manufacturing a layered memory object. The method includes the operation of producing a first coin layer from a precious metal using mass production techniques. A second coin layer can be created using a material that is less expensive than the first coin layer. The second coin layer can be customized with a customizable image. The first and second coin layers can be adhered together. The customized image can be configured to be viewed by a coin viewer.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates a layered memory coin as in an embodiment of the invention;

FIG. 2 illustrates a coin holder for use with the lasering techniques in accordance with an embodiment of the present invention; and

FIG. 3 is a cross-sectional view of a plurality of holders which can be provided to allow a laser to engrave on multiple coins in a rack of FIG. 2.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention includes an item or device that can mark a timeline for a person's life or specific events associated with a person's life. In addition, the present invention provides items, coins, boxes, and other beautiful jewelry that have a consistent branding and look and feel to the items.

The coins of the present invention can be serialized and contain typing or engravings that are associated with specific dates, times, people, etc. These coins, boxes and frames also help display the memories and events that occur in an individual's life. These items can be collected and displayed together in a pleasing manner.

In the past, coins have not generally been considered jewelry. The present invention includes coins that can be worn as bracelets, necklaces, earrings, or are in other ways suitable for an individual wearer. In the past, people have collected and traded monetary coins because the monetary coins were serialized, dated, related to a specific foundry, and had inherent economic value. Some commemorative types of medallions do exist on the market but these are merely decorative and are not associated with the dates of a person's life and have not been individually customized.

Individuals desire to have a relatively less expensive product that can be purchased to represent a person's life history. The coins of the present invention can be marked for events that happen between life and death and may be dated based on the specific life event. A brand can also be associated with these coins. These coins can be double sided and have either embossing, sculpturing or engraving on each side of the piece of jewelry. In the past, jewelry has not generally had double-sided decorative features. Typically a locket or some similar item will be engraved or sculptured on one side but not on both. The double-sided engravings allow life events and other similar important information to be located on both sides of the coin or jewelry.

Several particular embodiments of the invention will now be described. One embodiment of the invention is a coin to record an individual's life history. These coins can represent important events in a person's life. The coins are comparatively inexpensive but are valuable because the coins may include precious metals, stones and other similar items. Each coin will have a consistent look and feel for the series of coins. The coins can be various sizes, shapes and colors as determined by the specific series of coins.

Each of the coins will have a serial number engraved or sculpted onto the coin. In the past, coins and jewelry that have been sold on the market have not had serial numbers. The serial numbers can be formatted in any number of different ways. One particular formatting that captures a number of items of interest is a serialization that contains the following important information:
A batch number which represents a manufacturing run;
A mold number which is the device, machine or mold that has made the product;
A sequence number which is the actual item identification;
An event number which represents the event in a person's life that is being recognized;
A design number which represents the location where the item has been designed;
A cast number which represents the location where the item has been cast.

The coins in the present invention can be used to create a calendar based on a timeline of a person's life. For example, an individual coin can represent anniversaries, birthdays, or other events that are pertinent to an individual's life. The coins can also be related to other events such as awards for service, length of service, excellence in a specific area. In addition, the coins may represent businesses that a person has worked for or businesses that a person has done business with.

Being able to provide a coin for these different life events allows individuals to provide a gift for the person who has everything. A coin is durable gift that is personalized in the present invention. These customized coins can be displayed together in a frame or some other wall hanging.

In an alternative embodiment of the invention, a coin can be created for each person in a family. For example, mother, father, children, grandparents and extended family and these coins can be displayed in a family tree.

The coins do not necessarily have to be solid and they can have holes or be made of a variety of combined materials. For example, a coin can have stones, precious gems or other materials combined into the coin. Regardless of what the coin is made of, the coin will describe when it was made, where it was made, and meaningful events in an individual's life that the coin represents. As a result, these coins become historical markers and family heirlooms. In addition, the coin may also include information about the person who gave the gift. Alternatively, the company who sells the coin can track the gift giver and gift receiver in a database.

Another alternative use of the coin is to certify specific stories and memories associated with unique products such as antiques, rocks, pets, children, and memorabilia.

The coin can be marked with certain acronym letters to represent the type of memory coin it is. These markings can include M for memory coin, E for a limited edition coin, L for licensed coin, and O for an original coin. These markings are used to show the value of the coin.

Bezels can also be included on the coin. A bezel or beveled edge can be included on one side of the coin to attach the coin to other products or material. For example, a glass or crystal layer can be attached to the coin using a bezel. The bezel can be used with a hook or other attachment device to attach the coin to other jewelry, necklaces, or similar jewelry.

Another item that can be included with the present invention as a memory item is a two-sided picture frame. In the past, people have had one-sided picture frames that are decorated on a single side. These two-sided picture frames can be used to display coins. Thus, the two-sided picture frames complement the two-sided coins.

Another part of the memory items and system are memory boxes. These boxes may be imprinted with serial numbers and/or events in a similar manner as the coins. The boxes and frames can be marked with special events in a person's life.

Memory badges can also be provided for conferences, events or other special meetings. For example, a person can receive a coin and a badge together or a coin embedded in a badge to help remember a high level technical conference or a conference where they presented a paper.

The badges for events can also be used to control restricted items. For example, colored coins can be given to individuals who are of age to purchase controlled substances, such as alcohol at an event (e.g., a state or county fair). In addition to a colored coin, a person may receive a colored band based on the day's date. The band will have unique information to identify an individual and the person who receives the band can fill out an entry form with personal information. This aids law enforcement in tracking such persons and it allows insurance companies to lower the liability costs for events such as sporting events, fairs, and other areas where controlled substances are sold.

Another embodiment of the memory coin is a birthday collection. A birth coin can be created for an individual, including their birth date, where that person was born, and the coin can be serialized. This birth date coin can be the beginning of a lifetime set of coins that an individual collects and displays in a frame or memory box.

### Method for Manufacturing Coins

One of the reasons why there has previously been no significant market for custom coins or custom collector's coins is because of the difficulty in manufacturing custom coins at an affordable price. In order to create a coin, there are significant manufacturing setup and mold creation costs. For example, to manufacture a custom coin, an expensive casting mold is often created which can cost hundreds or thousands of dollars.

Alternatively, a stamping method can be used to create coins. Coin stamping includes a significant amount of setup costs and a relatively large number of stamped coins must generally be made in order to make the setup costs worthwhile (e.g., 1000 coins). This means that someone who desires to make a customized coin where each coin is individually customized is not able to because of the manufacturing setup costs and the multiple copies of the coin which are typically made. Thus, it is not generally feasible to manufacture a single custom coin or a few coins with the molding or stamping manufacturing methods.

Another method of manufacturing the coin is the method of cloisonné where glass is fused to metal using expensive heating equipment. In this process, a coin is either stamped or cast and then an additional glass part of the coin is melted, fused, or heat fastened to the coin.

The problem with all these manufacturing processes is that they are relatively expensive. In addition, the mindset of coin manufacturers has been that these methods are the primary ways to manufacture coins. The expectation is that coin manufacturers use expensive molds, stamps, or expensive machinery to create coins. Therefore, it is difficult to create an individual custom coin or low volume coins. For example, one or two coins cannot generally be created economically for an individual or for a single event.

The present invention is a system and method for manufacturing and/or assembling single unique coins or low volume coins in an economical manner. For example, the coins may include a custom birth date, anniversary or some other specific collectible information as discussed previously. The present invention combines the attributes of stamped or cast coins with the customizable aspects of engraving, laser engraving, or customizable stamping.

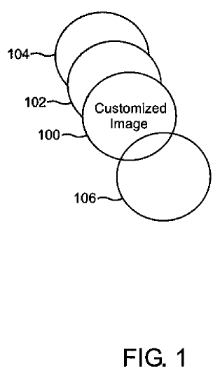

The present invention includes at least two layers that are combined to create a coin. FIG. 1 illustrates that the first layer 104 is a stamped for the front or back of the coin, and this first layer can be stamped from a precious or semi-precious malleable material. This stamped or cast part of the coin will be the same for a series of coins that are manufactured. This allows the invention to capture the value of a mass-produced coin. For example, the stamped portion can be stamped from gold, silver, platinum or some other precious metal.

A second layer 100 can be created for the front or back of the coin that is a customized piece for the coin. This is a layer that will have a customized image and/or message engraved or laser engraved on the layer. For example, many relatively less expensive lasers can engrave on aluminum, brass, bronze, or other metals that are engraveable. In addition to normal engraving, any type of anodized metal or anodized aluminum can be engraved upon. The stamped, cast, or cloisonnéd portioned of the coin (whether front or back) and the customized piece (whether front or back) are then combined together by an adhesive layer 102. Combining these two coin pieces together with an adhesive layer avoids the expensive heating or melting processes that are otherwise used in coin manufacturing. The adhesive layer can be any type of know industrial or household adhesive known to those skilled in the art. In addition, the present invention provides customizable coins that are economical to manufacture in small (or even large) quantities.

The second layer can be made by using cloisonné, cloisonné epoxy-dome, casting, die struck, die cast, soft-enamel, printed paper, engraved wood, roll and press, and other known processes. The second layer can be soldered or glued to the first layer. In other words, there is a foundation layer and a customization layer. In this sense, the first layer can be looked at as the foundation layer which has the same look and feel across each coin set. Then the customization layer is modified and attached to the foundation. The present invention should not be construed to limit the material that may be used in these layers. The foundation layer can be made out of any type of material, while the customized layer can be made of any type of material and manufactured using any processes that change the coin face.

One advantage of the present invention is that the coins and memory items are able to use laser type of engravings in combination with precious metals. In the past, it has not generally been possible to provide laser type engravings on silver, gold or other highly reflective precious metals. Thus, the present invention is able to combine precious or fine metals such as silver and gold together with other more customizable and engravable metals such as aluminum, brass, or anodized metal.

It is also possible to cloisonné additional materials on top of the coin faces, into the coin face, or between the sandwiched pieces. This is not necessary but can be used if the appropriate heating and melting equipment is available.

The shape of either side of the coin does not necessarily have to be round. The piece that is stamped, cast or cloisonnéd can be square, irregular or any other artistic or useful coin type of shape. Further, the customized piece can be square, irregular or any other artistic or useful shape.

The present invention provides significant advantages over the prior art because in the past manufacturers have not mixed fine metals with laser engraving techniques. This opens up an entirely new manufacturing arena that can include manufactured items such as customized game pieces, jewelry, coin art, or any other electronic media image that can be engraved onto a coin.

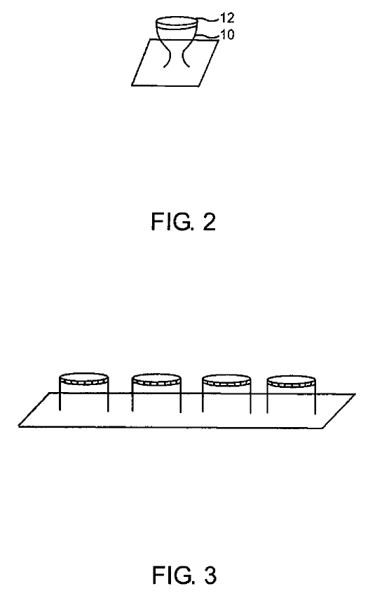

Although one side of the coin will be stamped or cast, the remaining side of the coin is prepared for either engraving or lasering. Since these are individual pieces that need to be engraved, it is important to provide an economical way to be able to apply a laser or engraving to the customizable side of the coin. Specifically, the present invention provides a coin holder for the lasering techniques. A first method of applying a laser to the coin would be to provide an individual holder 10 made of metal to hold the coin 12 as illustrated in FIG. 2. Alternatively, a plurality of holders can be provided to allow a laser to engrave on multiple coins in a rack as in FIG. 3. Alternatively, the coins may be stamped partially out of a single metal sheet with a small portion of the metal attaching the coins to the sheet. After laser engraving, the coins can be either cut or pulled from the sheet.

The present invention enables individuals to further customize a side of the coin with the laser engraving. The customizations that can be added can include the accomplishments of an individual, awards for individuals, life events or any other customized individual items that a user may desire to put on the customizable side of the coin. In addition, the present invention provides consistency across all the coins. One side of the coin can be the stamped from a precious or fine metal which will be the same for every single coin. The reverse side can be the customizable side. This allows a user to receive a branded coin that is customized for their specific needs on the reverse side. In addition, these customizable coins can be packaged with CDs, books or other collectible items. This way a serialized or customized coin can be provided with a first edition or limited edition collectible media. Moreover, customizable fine coins can be created for memorabilia, fundraisers, celebrities or patriotic events. This customizable coin can be combined with a necklace, a wristband or some other holder that is known to those skilled in the art.

In a further embodiment of the invention, the coin can contain more than three layers. Additional engraveable layers can be layered on the customizable side of the coin. This enables a multi-dimensional effect to be applied to the customizable side of the coin. In addition, the customizable parts of the coin or a segment of a customizable piece of metal smaller than the overall coin size can be affixed to either side of the coin. It can be imagined that many shapes or fragmentary parts of a decorative design can be layered on the customizable side of the coin to create an artistic impression.

An additional advantage of the present invention allows a coin manufacturer to combine multiple materials into the coin. For example, one side of the coin may be of precious metal such as platinum, silver or gold, which is the more expensive side of the coin, but the reverse side of the coin is made of a less expensive metal that is customizable and resembles the expensive side of the coin. For example, the reverse side may be aluminum or brass. The value of this is that the coin can be made for a lower cost because only half of the coin is made of the precious metal.

The combination of a pre-made coin face (or back) in combination with a customizable coin back (or face) enables any customer to receive a customizable coin without the cost of casting or molding an entire coin set. Creating a mold for a coin that has limited use costs several hundred up to thousands of dollars. While a mold that is created of materials that can be used in an unlimited process currently costs about $50,000. Thus, the present invention provides a way for multiple individuals to receive their own customized coins without these startup costs.

Another layer that can be contained on the coin is a bezel layer. This bezel layer will can be placed over the customizable part of the coin. This bezel allows a crystal or some other glass piece to be applied over the customizable face of the coin. Using a bezel technique helps protect the customized artwork that is applied to the coin. The bezel can also be applied to the precious metal or semiprecious metal face of the coin. The bezel layer can be considered yet another layer of the coin. In the prior art, a coin manufacturer has not been able use a multi-layered coin approach to provide a customized coin for any customer who desires one.

This layered approach enables the manufacturer of the customized coins to recycle coins that have not been used for an event. The more costly part of the coin (e.g., gold, silver, etc.) can be separated from the customized portion of the coin using solvents to remove the adhesive. Then a newly customized piece can be re-attached to the more expensive part of the coin. This makes the coins re-usable if they are not sold or given away at a certain event.

### Marketing Methods for Collectibles/Memorabilia

The product or service market does not provide an item or device that marks a timeline for a person's life or specific events associated with a person's life. Since the present invention includes a different product for each point in time in a person's life, the memory items can also be personalized, branded, dated, certificated, registered, sequenced items. In the personalization area, prior memorabilia manufactures have not provided engraving, printing, packaging, etc. which focuses on the life event market. Since there is generally no current market in timeline events, collectibles and memorabilia do not provide sequence numbering, serialization, certification of the product being sold, or a description of the products or specific events. The current memorabilia market tends to handle memory items one holiday at a time.

The branded market frequently uses one brand name that it is focused on, like Xerox, Pepsi, etc. To aid in entering the collectibles or memorabilia market, the present invention can use a long and short mark that means the same thing. The collectible items can use two marks that mean the same thing. The short mark is used on small surfaces, like jewelry, while longer mark is used on larger surfaces like publications, etc. For example, a short mark “MM” can be used on the coin in small areas and the longer mark Memory Mint can be used where there is more space or in the promotional literature.

### Packaging Market

When placing an importance on collectibles, the present invention can also focus on personalization, dates, serialization, branding, descriptions, certifications, and any similar information. This allows the invention described to provide collectable packaging. An example is pre-packaging of give-a-ways. An item can be pre-packed for parties, so the item is at a table and the box has sequential number or collectible coin for each give away item. This gives music sales, movie sales, etc. with new ways of marketing. This invention adds a new marketing scheme to the packaging world by adding the customized coin or layered object to products.

### Collectibles Market

The collectibles and memorabilia market have addressed one item at a time in the past. They also address and market different products individually, like caps, beanie babies, calendars, etc. With a consistent look and feel, the present invention provides many different ways of packaging these collectibles. With the use of one consistent product, the market can group other collectibles and memorabilia with the consistent item. With consistent packaging, the market takes the consistent collectible or memorabilia and can then use new products, such as tracking bands or badges to control events. With a consistent look, the collectibles and memorabilia can then be more appealing to look at in one collection.

### Award Market

There is no consistent look or feel in the collectibles market across different types of collectibles. An individual can collect a trophy or medallion for sports, a certificate for the completion of education, etc., but these items each have a different look and feel. Since there is a consistent look and feel to the present invention, this product can be sold with other third-party awards as a collectible, or as an award by itself. The present invention provides an item small enough to combine with other products or to be included together with items distributed at events.

### Currency Market

In the private currency market, the currency market focuses on one chronological event at a time or one promotional event. In the government market, the currency produced is the same product over and over. Since both markets are manufacturing one ‘currency’ at a time, the currency and coin manufacturers do not look at branding, timelines, etc. These manufacturers do not include personalization, brands, dates, certifications, serializations, or descriptions with a timeline or personal events. Therefore, the packaging techniques and jewelry techniques which are currently used by currency manufacturers are limited to what is currently provided in the known currency collectors market.

In the private and government sector, currency is a made of one material and one style of manufacturing process is used. Most coins are either die stamped or cast. Thus, known methods do not provide customized coins. The present invention addresses some of the needs of the jewelry market and the use of customized coins or currency in that market. Jewelry manufacturers do not manufacture for a custom coin market, because the custom coin market is so individualized that it has not been profitable until the present invention. This invention can also use necklace bails, jump rings, charm bracelets, charm necklaces, coin rings, coin bezels, etc. to display these coins. This invention can also use watch crystals to frame the artwork. The present invention can use a crystal over the coin without any jewelry and jewelry lockets can also be used. The present invention can use a combination of watch techniques and locket techniques together. The currency can be used with saddles, belts buckles, etc.

The present invention also uses customized frames, boxes, etc. The difference as compared to prior display methods is that this invention can use a dual picture frame. Since the invention is selling collectibles, an expandable or growing frame can be beneficial. This frame includes a top, middle, or bottom. The middle holds the collection of memorabilia, while the top and bottom can hold collectibles and/or decorations. The frame can be sold as individual units.

There is minimal use of technology in the collectibles and memorabilia market. There are no databases to track and certify collectable items. There is technology in some new collectibles like mugs, hats, etc., but they do not track their products. There is no technology used in combination with collectibles and memorabilia to track sold items, the value of sold items, etc. Using database technology along with the customization of the present invention, a business or individual can tell more about the item and value of an item which individuals are collecting.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A method for manufacturing a customized coin having a plurality of coin layers, comprising the steps of:
producing a first coin layer from a precious metal using mass production techniques;
creating a second coin layer using a material that is less expensive then the first coin layer;
customizing the second coin layer with a customized image;
adhering the first and second coin layers together, the customized image being configured to be viewed by a coin viewer.

2. A method as in claim 1, wherein the step of customizing the second coin layer with an image, further comprises the step of engraving or sublimating the customized image on the second coin layer.

3. A method as in claim 1, further comprising the step of producing the first coin layer using a precious metal selected from the group consisting of gold, silver, and platinum.

4. A method as in claim 1, wherein the step of producing the second coin layer further comprises the step of producing the second coin layer using a less precious metal that is selected from the group consisting of aluminum, brass, bronze and anodized metal.

5. A method as in claim 1, wherein the step of producing the second coin layer further comprises the step of producing the second coin layer using a less precious engraveable material selected from the group consisting of plastic, wood, stone, glass, and paper.

6. A method as in claim 1, wherein the step of producing the second coin layer further comprises the step of creating the second coin layer using manufacturing processes selected from the group consisting of cloisonné, cloisonn\acute{e} epoxy-dome, casting, die struck, die cast, soft-enamel, printed paper, engraved wood, soldering, gluing, and roll and press.

7. A method as in claim 6, wherein the step of producing the second coin layer further comprises the steps of:
applying a plurality of layers over the first coin layer; and
using a plurality of manufacturing processes to apply the plurality of layers.

8. A method as in claim 1, wherein the step of producing a first coin layer further comprises the step of producing the first coin layer made of a precious metal using mass production techniques selected from the group consisting of die stamping, casting, or die striking.

9. A method as in claim 1, further comprising the step of detaching the first coin layer and second coin layer in order to refurbish the first coin layer and attach an additional coin layer over the first coin layer.
